(19) United States
(12) Patent Application Publication
(10) Pub. No.: US 2025/0229785 A1
(43) Pub. Date: Jul. 17, 2025

(54) METHOD OF CONTROLLING OPERATION OF A VEHICLE, COMPUTER PROGRAM, COMPUTER-READABLE MEDIUM, CONTROL ARRANGEMENT, AND VEHICLE

(71) Applicant: Scania CV AB, Södertälje (SE)

(72) Inventors: Manne Held, Falun (SE); Henrik Sandstedt, Hägersten (SE)

(73) Assignee: Scania CV AB, Södertälje (SE)

(21) Appl. No.: 18/983,992

(22) Filed: Dec. 17, 2024

(30) Foreign Application Priority Data
Jan. 16, 2024 (SE) 2450043-1

(51) Int. Cl. B60W 30/182; B60W 10/06; B60W 10/18; B60W 30/18

(52) U.S. Cl. CPC B60W 30/182; B60W 10/06; B60W 10/18; B60W 30/18072; B60W 30/18127; B60W 2520/10; B60W 2552/15; B60W 2554/4041; B60W 2554/4042; B60W 2554/4045; B60W 2556/10; B60W 2556/40; B60W 2710/06; B60W 2710/18; B60W 2720/10

(57) ABSTRACT

A method of controlling operation of a vehicle is disclosed, wherein the vehicle comprises a propulsion system, wherein the method is performed by a control arrangement, and wherein the control arrangement is configured to operate the propulsion system in at least two modes of operation with differing energy conservation characteristics. The method comprises switching between the at least two modes of operation based on an obtained probability of a possible impending slowdown of a preceding vehicle. The present disclosure further relates to a computer program, a computer-readable medium, a control arrangement, and a vehicle.

### TECHNICAL FIELD

The present disclosure relates to a method of controlling operation of a vehicle. The present disclosure further relates to a computer program, a computer-readable medium, a control arrangement, and a vehicle comprising a propulsion system and a control arrangement.

### BACKGROUND

Propulsion systems are used in vehicles to provide motive power to the vehicle. Traditionally, these systems have been primarily powered by internal combustion engines, which convert chemical energy from fuel into mechanical energy. However, with advancements in technology and growing environmental concerns, alternative forms of propulsion have gained prominence. These include hybrid systems, which combine the traditional internal combustion engine with electric power, and fully electric systems, which rely solely on electric motors supplied with electricity from batteries, from fuel cells, and/or from an external source such as a pantograph.

Each type of propulsion system offers distinct advantages and challenges. Internal combustion engine systems are known for their high power output and long-range capabilities, but they also contribute to environmental pollution and have relatively low energy efficiency as compared to most electric systems. Hybrid systems attempt to balance the benefits of combustion engines and electric motors, offering improved fuel efficiency and reduced emissions. Fully electric vehicles can eliminate direct emissions and can offer high energy efficiency, but face challenges such as limited range and longer refueling times compared to vehicles operating on conventional fuels.

Controlling the operation of a vehicle for optimal energy efficiency poses significant challenges, particularly in certain driving conditions that involve other traffic. In dynamic traffic situations, variables such as frequent stop-and-go movements, unpredicted actions of other drivers, and varying speed limits require continuous adjustments in vehicle operation. These factors can lead to inconsistent engine or motor performance, increased fuel consumption or battery drain, and higher emissions in combustion and hybrid systems. Additionally, the need to constantly adapt to changing traffic patterns can prevent the propulsion system from operating at its most efficient state, which is often achieved at steady speeds or under specific load conditions.

Regenerative braking systems of vehicles are designed to recapture energy during vehicle deceleration. Regenerative braking system exist in various forms across different vehicles. In at least partially electric vehicles, such as fully electric and hybrid electric vehicles, one common approach is to store at least a portion of the electricity generated by the electric motor during braking in an electric energy storage system of the vehicle. The electric energy storage system may comprise a number of batteries and/or a number of supercapacitors. The stored energy can subsequently be used to propel the vehicle, and/or to power other systems of the vehicle, thus enhancing the overall energy efficiency of the vehicle. Another type of auxiliary braking system employs flywheel energy storage, which harnesses the braking energy to spin a flywheel, which can then release this energy to assist in propelling the vehicle during acceleration. Moreover, hydraulic regenerative systems, especially prevalent in some larger vehicles like buses, store energy by pressurizing hydraulic fluid, which can later be used to aid in propulsion of the vehicle.

The primary purpose of regenerative braking systems is to reduce the overall energy consumption of the vehicle and extend the range of vehicles. By recovering energy that would otherwise be wasted, regenerative braking systems contribute to enhancing the overall energy efficiency of these vehicles.

However, in certain driving situations, especially in emergency scenarios or under heavy braking, the use of traditional wheel brakes is necessary. While regenerative systems are highly effective in normal conditions, they are not always sufficient to provide the required stopping power in all situations. The reliance on wheel brakes in these instances leads to a direct loss of kinetic energy as heat, which reduces the total energy efficiency of the vehicle.

This is particularly evident in stop-and-go traffic conditions and urban driving, where frequent braking is common. The need to alternate between regenerative and conventional braking systems highlights the complexity of optimizing energy efficiency in real-world driving scenarios, underscoring the challenge of maintaining optimal energy recovery while ensuring safe vehicle operation.

Moreover, a frequent use of wheel brakes not only leads to a loss of kinetic energy but also results in increased wear and tear of the brake components. This wear and tear necessitate more frequent maintenance and replacement of brake parts, which adds to the overall operating costs and environmental impact due to the manufacturing and disposal of these components. Furthermore, heavy braking using the wheel brakes of a vehicle can negatively affect the driving dynamics and handling of the vehicle, potentially compromising the safety of vehicle operation. Moreover, intense braking can also accelerate the wear and tear of various vehicle components and systems, impacting their longevity and overall reliability.

In addition to the considerations outlined above, rough driving dynamics can compromise passenger comfort, increase wear and tear on vehicle components, and decrease the safety of vehicle operation. Additionally, rough driving dynamics increase the risk of cargo shifting or sustaining cargo damage during transit.

### SUMMARY

It is an object of the present invention to overcome, or at least alleviate, at least some of the above-mentioned problems and drawbacks. The object is achieved by the subject-matter of the appended independent claim(s).

According to a first aspect of the present disclosure, the object is achieved by a method of controlling operation of a vehicle, wherein the vehicle comprises a propulsion system, and wherein the method is performed by a control arrangement, the control arrangement being configured to operate the propulsion system in at least two modes of operation with differing energy conservation characteristics. The method comprises the step of:
switching between the at least two modes of operation based on an obtained probability of a possible impending slowdown of a preceding vehicle.

Since the method comprises the step of switching between the at least two modes of operation based on the obtained probability of a possible impending slowdown of the preceding vehicle, a method is provided having conditions for operating the propulsion system, and thus also the vehicle, in a more energy efficient manner in more varying driving conditions that involve other traffic. This is because the switching between the at least two modes of operation based on the obtained probability of a possible impending slowdown of a preceding vehicle can ensure an adaptive control of the propulsion system based on said probability.

Moreover, a method is provided having conditions for reducing the need for using wheel brakes for slowing down the vehicle in the event of an actual subsequent slowdown of the preceding vehicle. As a further result thereof, a method is provided capable of improving the total energy efficiency of the vehicle, reducing wear and tear of wheel brakes of the vehicle, and enhancing the driving dynamics and handling of the vehicle in an adaptive manner.

Accordingly, a method is provided overcoming, or at least alleviating, at least some of the above-mentioned problems and drawbacks. As a result, the above-mentioned object is achieved.

Optionally, the at least two modes of operation comprise a default mode and an energy conservation mode, wherein the energy conservation mode differs from the default mode by having a higher short term energy conservation aim than the default mode, and wherein the method comprises the step of:
switching from the default mode to the energy conservation mode when the obtained probability reaches above a threshold probability.

Thereby, improved conditions are provided for operating the propulsion system, and thus also the vehicle, in a more energy efficient manner in more varying driving conditions that involve other traffic. Furthermore, a method is provided capable of further reducing the need for using wheel brakes for slowing down the vehicle in the event of an actual subsequent slowdown of the preceding vehicle. Accordingly, a method is provided capable of improving the total energy efficiency of the vehicle, as well as the handling and driving dynamics of the vehicle, while minimizing wear and tear of wheel brakes of the vehicle.

Optionally, the method comprises the steps of, when the vehicle is approaching an uphill slope:
increasing the speed of the vehicle above a set speed upon operating the propulsion system in the default mode, and
abstaining from increasing the speed of the vehicle above the set speed upon operating the propulsion system in the energy conservation mode.

Thereby, a method is provided capable of further improving the total energy efficiency of the vehicle, as well as the handling and driving dynamics of the vehicle, while minimizing wear and tear of wheel brakes of the vehicle. This is because by increasing the speed of the vehicle above the set speed, when the propulsion system is operating in the default mode and the vehicle is approaching an uphill slope, the total energy efficiency of the vehicle can be enhanced. This efficiency gain is achieved by avoiding high-load conditions on the propulsion system while ascending the uphill slope, which are typically less efficient. That is, by increasing the speed of the vehicle above the set speed in anticipation of the uphill slope, the vehicle can tackle the incline more efficiently, using the gained momentum to reduce the strain on the propulsion system.

Likewise, the total energy efficiency of the vehicle can be increased by abstaining from increasing the speed of the vehicle above the set speed when the vehicle is approaching the uphill slope upon operating the propulsion system in the energy conservation mode, i.e., when the obtained probability has reached above the threshold probability. This is because the energy needed for performing a speed increase can be saved in situations having a high probability of a possible impending slowdown of a preceding vehicle. As a further result thereof, the use of the wheel brakes can be minimized to reduce wear and tear thereof and to improve driving dynamics and handling of the vehicle in an adaptive manner.

Optionally, the method comprises the steps of, when the vehicle is approaching an end of a downhill slope:
increasing the speed of the vehicle above a set speed upon operating the propulsion system in the default mode, and
abstaining from increasing the speed of the vehicle above the set speed upon operating the propulsion system in the energy conservation mode.

Thereby, a method is provided capable of further improving the total energy efficiency of the vehicle, as well as the handling and driving dynamics of the vehicle, while minimizing wear and tear of wheel brakes of the vehicle. This is because by increasing the speed of the vehicle above the set speed, when the propulsion system is operated in the default mode and the vehicle is approaching an end of a downhill slope, the total energy efficiency of the vehicle can be enhanced. This efficiency gain is achieved by harnessing the gravitational assistance during the descent of the downhill slope. By proactively accelerating above the set speed before reaching the end of the downhill slope, the vehicle can efficiently transition into level ground or an uphill slope. This strategy can thus reduce the propulsion system's workload to regain speed on flatter terrain, typically requiring higher energy expenditure. Accordingly, increasing the vehicle's speed above the set speed as the vehicle nears the end of a downhill slope can optimize the use of gravitational momentum, thereby reducing the overall energy demand on the propulsion system and improving the total energy efficiency of the vehicle.

Likewise, the total energy efficiency of the vehicle can be increased by abstaining from increasing the speed of the vehicle above the set speed upon operating the propulsion system in the energy conservation mode, i.e., when the obtained probability of a possible impending slowdown of a preceding vehicle has reached above the threshold probability. This is because the excess energy obtained by abstaining from increasing the speed of the vehicle can be effectively utilized for other functions, such as a regenerative recuperation of potential energy while descending the downhill slope, in situations having a high probability of a possible impending slowdown of a preceding vehicle. Moreover, by abstaining from increasing the speed of the vehicle above the set speed, the use of the wheel brakes can be minimized to reduce wear and tear thereof and to improve driving dynamics and handling of the vehicle in an adaptive manner.

Optionally, the method comprises the step of:
adapting the execution of a pulse-and-glide procedure of the propulsion system upon switching to the energy conservation mode.

Thereby, a method is provided having conditions for further improving the total energy efficiency of the vehicle, as well as the handling and driving dynamics of the vehicle, while minimizing wear and tear of wheel brakes of the vehicle in an adaptive manner. A pulse-and-glide procedure is a technique designed to optimize the energy efficiency of the propulsion system. The pulse-and-glide procedure involves alternating between periods of acceleration, i.e., pulse phases, and coasting, i.e., glide phases. This technique can save energy by reducing the average frictional losses in the propulsion system.

Optionally, the method comprises the step of:
initiating a freewheeling phase of the propulsion system upon switching to the energy conservation mode.

Thereby, a method is provided capable of further improving the total energy efficiency of a vehicle and improving the diving dynamics of the vehicle. This is because by initiating the freewheeling phase of the propulsion system upon switching to the energy conservation mode, the speed of the vehicle can be reduced in an initial phase in situations in which the obtained probability of a possible impending slowdown of a preceding vehicle reaches above the threshold probability. In case the preceding vehicle is actually slowing down, the reduced speed of the vehicle results in a reduced need for using wheel brakes of the vehicle for slowing down the vehicle, thereby saving energy and potentially improving the vehicle dynamics and handling. In case the preceding vehicle is not slowing down, the freewheeling phase can be followed by a power pulse for compensating for the loss of momentum of the vehicle. Accordingly, in this manner, the driving dynamics of the vehicle can be further improved in an adaptive manner based on the risk of a possible impending slowdown of a preceding vehicle.

Optionally, the propulsion system comprises an internal combustion engine, and wherein the method comprises the step of:
initiating a motoring phase of the internal combustion engine upon switching to the energy conservation mode.

Thereby, a method is provided capable of further improving the energy efficiency of the vehicle and improving the handling and driving dynamics of the vehicle, while minimizing wear and tear of wheel brakes of the vehicle in an adaptive manner. This is because by initiating the motoring phase of the propulsion system upon switching to the energy conservation mode, the speed of the vehicle can be reduced in an initial phase in situations in which the obtained probability of a possible impending slowdown of a preceding vehicle reaches above the threshold probability. By performing a motoring phase instead of a freewheeling phase, the risk of wasting fuel to idle the internal combustion engine is removed. Additionally, this approach enables the attainment of a greater retardation force on the vehicle. In case the preceding vehicle is actually slowing down, the initial greater retardation force results in a reduced need for using wheel brakes of the vehicle for slowing down the vehicle, thereby saving energy and potentially improving the vehicle dynamics and handling. In case the preceding vehicle is not slowing down, the motoring phase can be followed by a power pulse for compensating for the loss of momentum. Accordingly, in this manner, the driving dynamics of the vehicle can be further improved in an adaptive manner based on the risk of a possible impending slowdown of a preceding vehicle.

Optionally, the propulsion system comprises an internal combustion engine, and wherein the method comprises the steps of:
obtaining driving context data indicative of a driving environment of a current and/or upcoming road section on which the vehicle is/will be travelling, and
selecting, based on the driving context data, between initiating a motoring phase of the internal combustion engine or initiating a freewheeling phase of the propulsion system upon switching to the energy conservation mode.

Thereby, a method is provided capable of further improving the energy efficiency of the vehicle and improving the handling and driving dynamics of the vehicle, while minimizing wear and tear of wheel brakes of the vehicle in an adaptive manner based on the driving context and the risk of a possible impending slowdown of a preceding vehicle.

Optionally, the driving context data comprises at least one of a current speed of the vehicle and an inclination of a current and/or upcoming road section on which the vehicle is/will be travelling.

Thereby, a method is provided capable of further improving the energy efficiency of the vehicle and improving the handling and driving dynamics of the vehicle. This is achieved while minimizing wear and tear of wheel brakes of the vehicle in an adaptive manner based on the risk of a possible impending slowdown of a preceding vehicle and at least one of a current speed of the vehicle and an inclination of a current and/or upcoming road section on which the vehicle is/will be travelling.

Optionally, the propulsion system comprises a regenerative braking system controllable to regeneratively brake the vehicle, and wherein the method comprises:
increasing a braking level provided by the regenerative braking system upon switching to the energy conservation mode.

Thereby, a method is provided having conditions for further improving the energy efficiency of the vehicle and improving the handling and driving dynamics of the vehicle, while minimizing wear and tear of wheel brakes of the vehicle. This is because the increased braking power provided by the regenerative braking system can be converted into useful energy in situations in which the obtained probability of a possible impending slowdown of a preceding vehicle has reached above the threshold probability. Moreover, the increased braking power decelerates the vehicle which reduces the need for using the wheel brakes for slowing down the vehicle, which thus can minimize wear and tear of wheel brakes of the vehicle and potentially improve the driving dynamics and handling of the vehicle.

Optionally, the method comprises the step of:
obtaining the probability of a possible impending slowdown of a preceding vehicle.

Optionally, the step of obtaining the probability of a possible impending slowdown of the preceding vehicle comprises at least one of:
monitoring signaling lights of the preceding vehicle, and
monitoring a lateral position of the preceding vehicle relative to a road section on which the preceding vehicle is travelling.

Thereby, reliable and accurate possibilities of impending slowdowns of preceding vehicles can be obtained. In this manner, a method is provided having conditions for further improving the energy efficiency of the vehicle and improving the handling and driving dynamics of the vehicle, while minimizing wear and tear of wheel brakes of the vehicle, in an adaptive manner.

Optionally, the step of obtaining the probability of a possible impending slowdown of the preceding vehicle comprises:
obtaining map data representative of road section on which the preceding vehicle is/will be travelling, and
obtaining the probability of a possible impending slowdown of the preceding vehicle based on the map data.

Thereby, reliable and accurate possibilities of impending slowdowns of preceding vehicles can be obtained. In this manner, a method is provided having conditions for further improving the energy efficiency of the vehicle and improving the handling and driving dynamics of the vehicle, while minimizing wear and tear of wheel brakes of the vehicle, in an adaptive manner.

Optionally, the step of obtaining the probability of a possible impending slowdown of the preceding vehicle comprises:
obtaining historic data representative of historic speeds of vehicles on a road section on which the preceding vehicle is/will be travelling, and
obtaining the probability of a possible impending slowdown of the preceding vehicle based on the historic data.

Thereby, reliable and accurate possibilities of impending slowdowns of preceding vehicles can be obtained. In this manner, a method is provided having conditions for further improving the energy efficiency of the vehicle and improving the handling and driving dynamics of the vehicle, while minimizing wear and tear of wheel brakes of the vehicle, in an adaptive manner.

Optionally, the step of obtaining the probability of a possible impending slowdown of the preceding vehicle comprises:
obtaining communication data from an external sender, and
obtaining the probability of a possible impending slowdown of the preceding vehicle based on the communication data.

Thereby, reliable and accurate possibilities of impending slowdowns of preceding vehicles can be obtained. In this manner, a method is provided having conditions for further improving the energy efficiency of the vehicle and improving the handling and driving dynamics of the vehicle, while minimizing wear and tear of wheel brakes of the vehicle, in an adaptive manner.

According to a second aspect of the present disclosure, the object is achieved by a computer program comprising instructions to cause the control arrangement according to the second aspect of the present disclosure to execute the steps of the method according to some embodiments of the first aspect of the present disclosure. Since the computer program comprises instructions to cause the control arrangement to carry out the method according to some embodiments described herein, a computer program is provided which provides conditions for overcoming, or at least alleviating, at least some of the above-mentioned drawbacks. As a result, the above-mentioned object is achieved.

According to a third aspect of the present disclosure, the object is achieved by a computer-readable medium having stored thereon the computer program according to the second aspect of the present disclosure. Since the computer-readable medium comprises instructions to cause the control arrangement to carry out the method according to some embodiments described herein, a computer-readable medium is provided which provides conditions for overcoming, or at least alleviating, at least some of the above-mentioned drawbacks. As a result, the above-mentioned object is achieved.

According to a fourth aspect of the present disclosure, the object is achieved by a control arrangement configured to control operation of a vehicle, and wherein the vehicle comprises a propulsion system, and wherein the control arrangement is configured to operate the propulsion system in at least two modes of operation with differing energy conservation characteristics. The control arrangement is configured to switch between the at least two modes of operation based on an obtained probability of a possible impending slowdown of a preceding vehicle.

Since the control arrangement is configured to switch between the at least two modes of operation based on the obtained probability of a possible impending slowdown of the preceding vehicle, a control arrangement is provided having conditions for operating the propulsion system, and thus also the vehicle, in a more energy efficient manner in more varying driving conditions that involve other traffic. This is because the switching between the at least two modes of operation based on the obtained probability of a possible impending slowdown of a preceding vehicle can ensure an adaptive control of the propulsion system based on said probability.

Moreover, a control arrangement is provided having conditions for reducing the need for using wheel brakes for slowing down the vehicle in the event of an actual subsequent slowdown of the preceding vehicle. As a further result thereof, a control arrangement is provided capable of improving the total energy efficiency of the vehicle, reducing wear and tear of wheel brakes of the vehicle, and enhancing the driving dynamics and handling of the vehicle in an adaptive manner.

Accordingly, a control arrangement is provided overcoming, or at least alleviating, at least some of the above-mentioned problems and drawbacks. As a result, the above-mentioned object is achieved.

It will be appreciated that the various embodiments described for the method are all combinable with the control arrangement as described herein. That is, the control arrangement according to the fourth aspect of the invention may be configured to perform any one of the method steps of the method according to the first aspect of the invention.

According to a fifth aspect of the present disclosure, the object is achieved by a vehicle comprising a propulsion system and a control arrangement according to some embodiments of the present disclosure. Since the vehicle comprises a control arrangement according to some embodiments, a vehicle is provided overcoming, or at least alleviating, at least some of the above-mentioned problems and drawbacks. As a result, the above-mentioned object is achieved.

Optionally, the vehicle is a heavy road vehicle, such as a truck or a bus. Thereby, a heavy road vehicle is provided having at least some of the above-mentioned advantages.

Further features of, and advantages with, the present invention will become apparent when studying the appended claims and the following detailed description.

### BRIEF DESCRIPTION OF THE DRAWINGS

Various aspects of the present disclosure, including its particular features and advantages, will be readily understood from the example embodiments discussed in the following detailed description and the accompanying drawings, in which:

FIG. 1 illustrates a top-view of a vehicle according to some embodiments as positioned on a road section,

FIG. 2 illustrates a side-view of the vehicle on the road section illustrated in FIG. 1,

FIG. 3 illustrates a side-view of the vehicle illustrated in FIG. 1 on a second example of a road section,

FIG. 4 schematically illustrates a method of controlling operation of a vehicle, and

FIG. 5 illustrates a computer-readable medium.

### DETAILED DESCRIPTION

Aspects of the present disclosure will now be described more fully. Like reference signs refer to like elements throughout. Well-known functions or constructions will not necessarily be described in detail for brevity and/or clarity.

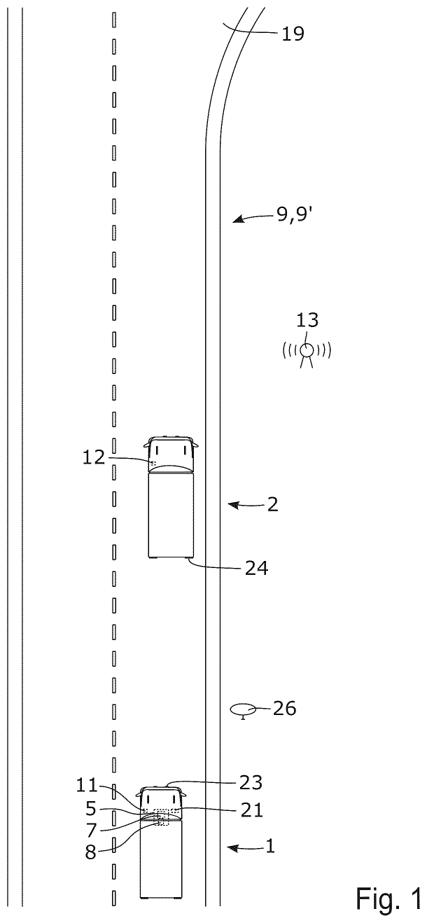

FIG. 1 illustrates a top-view of a vehicle 1 according to some embodiments as positioned on a road section 9 behind a preceding vehicle 2. According to the illustrated embodiments, the vehicle 1 is a truck, i.e., a type of heavy road vehicle as well as a type of heavy commercial vehicle. According to further embodiments, the vehicle 1, as referred to herein, may be another type of heavy or lighter type of manned or unmanned vehicle for land-based propulsion such as a lorry, a bus, a construction vehicle, a tractor, a car, or the like. Likewise, in the example illustrated in FIG. 1, the preceding vehicle 2 is a truck. However, obviously, the preceding vehicle 2, as referred to herein, may be another type of vehicle, such as a lorry, a bus, a construction vehicle, a tractor, a car, a motorcycle, or the like.

As indicated in FIG. 1, the vehicle 1 comprises a propulsion system 5 and a control arrangement 21. The control arrangement 21 is configured to control operation of the vehicle 1, including a control of operation of the propulsion system 5 of the vehicle 1, as is explained in greater detail below.

The propulsion system 5 is configured to provide motive power to the vehicle 1 via wheels of the vehicle 1. The wheels of the vehicle 1 are not indicated in FIG. 1 for reasons of brevity and clarity. According to the illustrated embodiments, the propulsion system 5 comprises a power source in the form of an internal combustion engine 7.

The internal combustion engine 7 may be a diesel engine, i.e. a type of compression ignition engine. The internal combustion engine 7 may thus be configured to operate on diesel or a diesel-like fuel, such as biodiesel, biomass to liquid (BTL), or gas to liquid (GTL) diesel. Diesel-like fuels, such as biodiesel, can be obtained from renewable sources such as vegetable oil which mainly comprises fatty acid methyl esters (FAME). Diesel-like fuels can be produced from many types of oils, such as rapeseed oil (rapeseed methyl ester, RME) and soybean oil (soy methyl ester, SME).

According to further embodiments, the internal combustion engine 7, as referred to herein, may another type of Otto engine with a spark-ignition device, wherein the Otto engine may be configured to run on petrol, alcohol, or combinations thereof. Alcohol, such as ethanol, can be derived from renewable biomass. According to embodiments herein, the internal combustion engine 7 is a four-stroke internal combustion engine.

Moreover, the internal combustion engine 7 may be an Otto engine with a spark-ignition device, wherein the Otto engine is configured to run on a gaseous fuel. The gaseous fuel may also be referred to as fuel gas and may encompass any type of fuel that under ordinary ambient temperature and pressure conditions are gaseous and which can be stored at pressure in a pressure tank and can be combusted in an internal combustion engine 7 to produce useful work. Examples of such gaseous fuels are compressed natural gas (CNG), liquified natural gas (LNG), Liquefied Petroleum Gas (LPG), Hydrogen (H2), Biogas, and Syngas. Many gaseous fuels can be derived from renewable sources, such as from renewable biomass.

Moreover, according to the illustrated embodiments, the propulsion system 5 of the vehicle 1 comprises a regenerative braking system 8 controllable to regeneratively brake the vehicle 1. In more detail, according to the illustrated embodiments, the regenerative braking system 8 comprises an electric machine controllable to regeneratively brake the vehicle 1, wherein the energy derived from braking the vehicle 1 can be stored in an electric energy storage system of the vehicle 1.

The electric energy storage system may comprise one or more propulsion battery packs each comprising a number of rechargeable battery cells, such as lithium-ion battery cells, lithium polymer batteries cells, nickel-metal hydride battery cells, or the like. The battery cells may be arranged in battery modules, wherein each of the one or more propulsion battery packs may comprise a number of battery modules. The stored energy can subsequently be used to provide motive power to the vehicle 1 utilizing the above mentioned electric machine. In other words, according to the illustrated embodiments, the vehicle 1 is a so called hybrid electric vehicle comprising the combination of an internal combustion engine 7 and an electric machine for providing motive power to the vehicle 1.

However, according to further embodiments, the vehicle 1, as referred to herein, may be fully electric vehicle comprising a pure electric propulsion system, i.e., a propulsion system comprising a number of electric machines and no internal combustion engine for providing motive power to the vehicle 1 via wheels of the vehicle 1. In such embodiments, the regenerative braking system 8 of the propulsion system 5 may comprise one or more of the number of electric machines.

Furthermore, according to some embodiments, the vehicle 1 may comprise an internal combustion engine 7 as the only means for providing motive power to the vehicle 1 and no electrical propulsion machine.

Moreover, the vehicle 1 may comprise another type of regenerative braking system 8 than explained above, such as a hydraulic or pneumatic regenerative auxiliary braking system. Such an auxiliary braking system may comprise a hydraulic or pneumatic pump/motor controllable to brake the vehicle 1 and to convert the braking energy into potential energy within a pressure tank by pumping a fluid into the pressure tank upon braking. In such embodiments, the pressurized fluid may be usable for subsequently providing motive power to the vehicle 1, for example using the pump/motor of the hydraulic or pneumatic regenerative auxiliary braking system. Moreover, according to some embodiments, the regenerative braking system 8 of the vehicle 1 may comprise a flywheel configured to store energy derived from braking in the form of rotation of the flywheel.

The vehicle 1 further comprises wheel brakes controllable to brake the vehicle 1. The wheel brakes may comprise friction brake arrangements, such as drum brakes, disc brakes, or a combination thereof. Drum brakes normally comprise a cylinder-shaped part called a brake drum and a set of shoes or pads controllable to be pressed against the cylinder-shaped part to create friction therebetween for braking rotation of the wheels. Disc brakes normally comprise a disc and a set of pads controllable to be pressed against the disc to create friction therebetween for braking rotation of the wheels.

As mentioned above, the control arrangement 21 of the vehicle 1 is configured to control operation of the vehicle 1, including operation of the propulsion system 5 of the vehicle 1. In more detail, according to embodiments herein, the control arrangement 21 is configured to operate the propulsion system 5 in at least two modes of operation with differing energy conservation characteristics. Moreover, the control arrangement 21 is configured to switch between the at least two modes of operation based on an obtained probability of a possible impending slowdown of a preceding vehicle 2. The control arrangement 21 may be configured to obtain the probability of a possible impending slowdown of the preceding vehicle 2 in various ways, as explained in more detail below.

According to the illustrated embodiments, the at least two modes of operation comprise a default mode and an energy conservation mode, wherein the energy conservation mode differs from the default mode by having a higher short term energy conservation aim than the default mode. The wording “higher short term energy conservation aim”, as referred to herein, may encompass that the energy conservation mode has a higher aim to conserve energy during a short time period than the default mode. Such a short period may range from a couple of tenths of a second to a number of seconds. In more detail, such short period may be within the range of 0.2-20 seconds, or may be within the range of 1-15 seconds.

Moreover, according to the illustrated embodiments, the control arrangement 21 is configured to switch from the default mode to the energy conservation mode when the obtained probability reaches above a threshold probability. In this manner, as is explained in greater detail herein, the control arrangement 21 can enhance the energy efficiency of the vehicle 1 and improve the handling and driving dynamics of the vehicle 1, while minimizing wear and tear of wheel brakes of the vehicle 1 in an adaptive manner based on the probability of a possible impending slowdown of the preceding vehicle 2.

The control arrangement 21 may be configured to obtain the probability of a possible impending slowdown of a preceding vehicle 2 by performing at least one of a monitoring of signaling lights 24 of the preceding vehicle 2 and a monitoring of a lateral position of the preceding vehicle 2 relative to a road section 9 on which the preceding vehicle 2 is travelling. That is, as depicted in FIG. 1, according to the illustrated embodiments, the vehicle 1 comprises a sensor assembly 23 configured to monitor a driving environment in front of the vehicle 1. The sensor assembly 23 is operably connected to the control arrangement 21. The sensor assembly 23 may comprise one or more of an image capturing device, such as a camera, a LiDAR (Light Detection and Ranging) sensor, a radar (Radio Detection and Ranging) sensor, and an ultrasonic sensor.

An image capturing device works by capturing visual data in the form of images or videos. This allows the control arrangement 21 to identify and interpret various aspects, such as the brake lights and turn signals of the preceding vehicle 2, as well as tracking the position and movement of the preceding vehicle 2. LiDAR sensors function by emitting pulsed laser light and measuring the time it takes for the light to bounce back after hitting an object. This data can be used to create accurate, three-dimensional information about the surrounding environment, including a distance and shape of objects, like the preceding vehicle 2. Radar sensors use radio waves to detect objects and determine their speed and distance. They emit radio waves that reflect off objects and return to the sensor, allowing the system to calculate the object's position and velocity, even in poor visibility conditions. Lastly, ultrasonic sensors work by emitting ultrasonic sound waves. These waves reflect off objects and return to the sensor, which then calculates the distance to the object based on the time it takes for the sound waves to return.

In embodiments in which the control arrangement 21 is configured to obtain the probability of a possible impending slowdown of a preceding vehicle 2 by monitoring signaling lights 24 of the preceding vehicle 2, the control arrangement 21 may be configured to perform a significant increase of the probability in case of a detection of an activation of one of brake lights, turn signals, and hazard lights of the preceding vehicle 2.

Moreover, in embodiments, which the control arrangement 21 is configured to obtain the probability of a possible impending slowdown of a preceding vehicle 2 by monitoring a lateral position of the preceding vehicle 2 relative to a road section 9 on which the preceding vehicle 2 is travelling, the control arrangement 21 may be configured to adjust the probability based on the lateral position of the preceding vehicle 2, and/or a lateral movement of the preceding vehicle 2. In some embodiments, the control arrangement 21 is configured to increase the probability of a possible impending slowdown of a preceding vehicle 2 in case the control arrangement 21 detects that the preceding vehicle 2 shifts its lateral position towards the outer side of the road section 9, which corresponds to the right on a right-hand driving road and to the left on a left-hand driving road.

Furthermore, according to some embodiments, the control arrangement 21 may be configured to obtain the probability of a possible impending slowdown of the preceding vehicle 2 based on map data representative of the road section 9 on which the preceding vehicle 2 is/will be travelling. The control arrangement 21 may be configured to obtain the map data from an onboard system or from an external sender 12, 13.

The vehicle 1 may comprise a vehicle positioning device configured to provide a current position estimate of the vehicle 1. Such a vehicle positioning device may for example utilize a space-based satellite navigation system such as a Global Positioning System (GPS), The Russian GLObal NAvigation Satellite System (GLONASS), European Union Galileo positioning system, Chinese Compass navigation system, or Indian Regional Navigational Satellite System. The control arrangement 21 may be configured to provide a current position estimate of the preceding vehicle 2 by comparing a current position estimate of the vehicle 1 and data from the sensor assembly 23. In some embodiments, the control arrangement 21 may be configured to obtain the probability of a possible impending slowdown of the preceding vehicle 2 by comparing a current position estimate of the preceding vehicle 2 and the obtained map data.

Furthermore, according to some embodiments, the control arrangement 21 may be configured to obtain the probability of a possible impending slowdown of the preceding vehicle 2 by identifying a geometrical, regulatory, and/or navigational alteration of a current and/or upcoming road section 9 on which the vehicle 1 is/will be travelling. According to some embodiments, the control arrangement 21 may be configured to identify such an alteration from the obtained map data. As an alternative, or in addition, the control arrangement 21 may be configured to identify such an alteration using data from the sensor assembly 23 of the vehicle 1.

The control arrangement 21 may be configured to identify a geometrical alteration in the form of at least one of a change in curvature of the road, a change in inclination of the road, a change in width of the road, and a change in type of road surface. As an alternative, or in addition, the control arrangement 21 may be configured to identify a regulatory alteration in the form of at least one of a speed limit change, a stop duty, a traffic signal location, a yield point, and a change in lane usage rules. The control arrangement 21 may be configured to identify a speed limit change by monitoring traffic signs 26 in the environment surrounding the vehicle 1 using data from an imaging unit of the sensor assembly 23 and/or by analysing the obtained map data. As a further alternative, or in addition, the control arrangement 21 may be configured to identify a navigational alteration in the form of at least one of a road exit 19, an intersection, a crossing, and a roundabout. The control arrangement 21 may be configured to adjust the probability a possible impending slowdown of the preceding vehicle 2 based on a distance between the preceding vehicle 2 and one or more of the above mentioned types of alterations.

According to some embodiments, the control arrangement 21 is configured to obtain historic data representative of historic speeds of vehicles on a road section 9 on which the preceding vehicle 2 is/will be travelling and obtain the probability of a possible impending slowdown of the preceding vehicle 2 based on the historic data. According to such embodiments, the control arrangement 21 may be configured to compare the historic data with a current position estimate of the preceding vehicle 2 and may be configured to increase the probability of a possible impending slowdown of a preceding vehicle 2 if the comparison indicates that the preceding vehicle 2 is approaching a road section 9 having reduced historic speeds of vehicles. The historic speeds of vehicles, as referred to herein, may be represented by average historic speeds of vehicles on a road section 9.

The control arrangement 21 may be configured to input the historic data from an onboard system or from an external sender 12, 13. As mentioned, the control arrangement 21 may be configured to obtain the position estimate of the preceding vehicle 2 by comparing a current position estimate of the vehicle 1 and data from the sensor assembly 23. The control arrangement 21 may be configured to obtain the current position estimate of the vehicle 1 using data from an onboard positioning system, such as a satellite-based positioning system.

Furthermore, the control arrangement 21 may be configured to obtain communication data from an external sender 12, 13, and obtain the probability of a possible impending slowdown of the preceding vehicle 2 based on the communication data. According to the illustrated embodiments, the vehicle 1 comprises a receiver 11 arranged on the vehicle 1. The receiver 11 is operably connected to the control arrangement 21 and the control arrangement 21 is configured to receive data therefrom. Moreover, as is illustrated in FIG. 1, the control arrangement 21 may be configured to obtain communication data from an external sender 12 arranged on the preceding vehicle 2 and/or from an external sender 13 having a fixed position relative to the road section 9, such as a sender of a communication unit for mobile devices.

The communication data may be representative of a future, upcoming, or imminent intent of the preceding vehicle 2. In embodiments in which the external sender 13 has a fixed position relative to the road section 9, the external sender 13 may be part of a roadside system, wherein the roadside system is configured to receive a future, upcoming, or imminent intent of the preceding vehicle 2, for example from a sender 12 arranged on the preceding vehicle 2, and transmit data indicative of the future, upcoming, or imminent intent to the receiver 11 of the vehicle 1.

According to some embodiments, the control arrangement 21 is configured to obtain the probability of a possible impending slowdown of a preceding vehicle 2 by combining various types of obtained data. As an example, in the illustrated example of FIG. 1, the preceding vehicle 2 is illustrated as approaching a road exit 19, i.e., a type of geometrical and navigational alteration. The control arrangement 21 may be configured to identify that the preceding vehicle 2 is approaching the road exit 19 by analysing obtained map data, and/or by analysing data from the sensor assembly 23, and may be configured to set the probability of a possible impending slowdown of the preceding vehicle 2 in response thereto.

For example, the control arrangement 21 may be configured to set the probability of a possible impending slowdown of a preceding vehicle 2 to a certain value, such as a certain percentage, for example 3-15%, if the control arrangement 21 identifies that the preceding vehicle 2 is approaching a road exit 19, but no other data indicates an intent of the preceding vehicle 2 to depart at the road exit 19. The control arrangement 21 may also be configured to adapt the probability of a possible impending slowdown of a preceding vehicle 2 based on obtained map data, and/or historic data, such that the probability is increased if the map data, and/or the historic data, indicates that road exit 19 is commonly used. Likewise, the control arrangement 21 may be configured to adapt the probability such that the probability is reduced if the obtained map data, and/or the historic data, indicates that road exit 19 is not commonly used. Moreover, according to some embodiments, the control arrangement 21 may be configured to identify the type of the preceding vehicle 2 and may adapt a determination of whether a road exit 19 is commonly used or not based on the type of the preceding vehicle 2. For example, some road exits 19 may be more commonly used by heavier types of vehicles, such as trucks, and the control arrangement 21 may be configured to adapt/adjust the probability accordingly.

To continue the above example, if/when further obtained data indicates an intent of the preceding vehicle 2 to depart at the road exit 19, for example if obtained data indicates a shift in lateral position of the preceding vehicle 2 towards the outer side of the road section 9, the control arrangement 21 may increase the probability of a possible impending slowdown of the preceding vehicle 2. In the above example, the control arrangement 21 may for example increase the probability from a value of 10% to a value between 25-75%.

Moreover, if/when even further obtained data indicates an intent of the preceding vehicle 2 to depart at the road exit 19, for example if obtained data indicates an activation of a turn signal of the preceding vehicle 2 in a direction towards the road exit 19, the control arrangement 21 may be configured to further increase the probability of a possible impending slowdown of the preceding vehicle 2. In the above example, the control arrangement 21 may for example further increase the probability to a value between 75-100%.

Moreover, according to some embodiments, the control arrangement 21 may be configured to assign different weights to various types of obtained data. Furthermore, the control arrangement 21 may be configured to assign different weights to various types of combinations of obtained data. That is, in such embodiments, the control arrangement 21 may give different priorities to different types of obtained data in the determination of the probability of a possible impending slowdown of the preceding vehicle 2. For example, a detection of an activation of a turn signal may be given a higher priority than a detection of a lateral shift of the preceding vehicle 2, whereas obtained communication data indicating a future, upcoming, or imminent slowdown intent of the preceding vehicle 2 may be given the highest priority among these examples.

Below, some examples of a default mode and an energy conservation mode of the propulsion system 5 are explained in greater detail. However, as specified herein, the control arrangement 21 may be configured to operate the propulsion system 5 in more than two different modes of operation each having a different energy conservation characteristic than the other modes of operation.

In embodiments in which the propulsion system 5 comprises a regenerative braking system 8 controllable to regeneratively brake the vehicle 1, the control arrangement 21 may be configured to increase a regenerative braking level provided by the regenerative braking system 8 upon switching from the default mode to the energy conservation mode. In other words, according to such embodiments, the control arrangement 21 may control the regenerative braking system 8 to provide an increased regenerative braking level when operating the propulsion system 5 in the energy conservation mode as compared to when operating the propulsion system 5 in the default mode. For example, the control arrangement 21 may be configured to control the regenerative braking system 8 to provide a braking level of 50-70% of a maximum regenerative braking level of the regenerative braking system 8 upon operating in the default mode and may be configured to control the regenerative braking system 8 to provide a braking level of 90-100%, or 95-100%, of a maximum regenerative braking level of the regenerative braking system 8 upon operating in the energy conservation mode. In this manner, the propulsion system 5, and thus also the vehicle 1, is operated with a higher short term energy conservation aim in the energy conservation mode as compared to when operating in the default mode.

As a further result of these features, the increased braking power provided by the regenerative braking system 8 can be converted into useful energy in situations in which the obtained probability of a possible impending slowdown of a preceding vehicle 3 has reached above the threshold probability. Moreover, the increased braking power decelerates the vehicle 1 which reduces the need for using the wheel brakes for slowing down the vehicle if the preceding vehicle 2 is actually slowing down. This control can thus minimize wear and tear of wheel brakes of the vehicle 1 and potentially improve the driving dynamics and handling of the vehicle 1 in an adaptive manner.

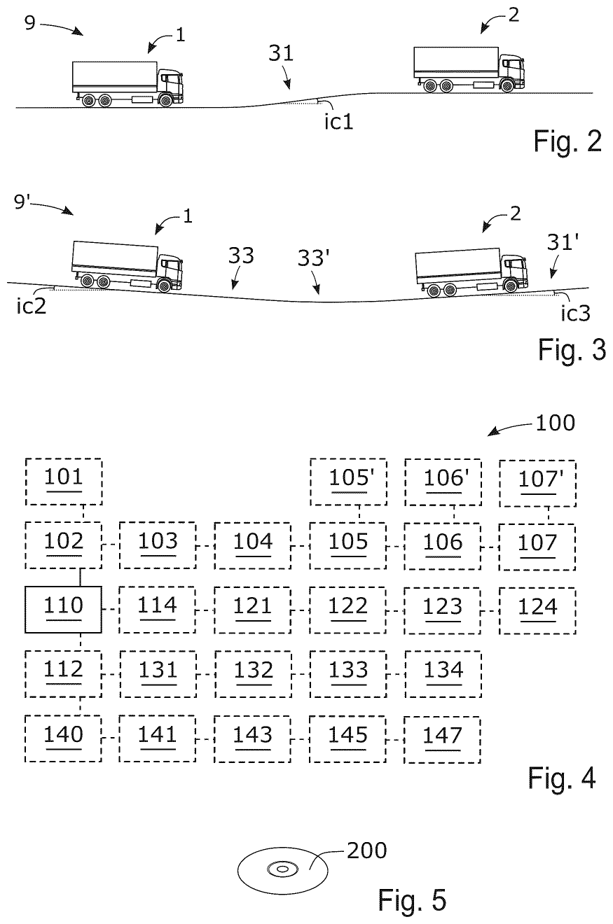

FIG. 2 illustrates a side-view of the vehicle 1 on the road section 9 illustrated in FIG. 1. The preceding vehicle 2 is also seen in FIG. 2. Moreover, in FIG. 2, the vehicle 1 is illustrated as approaching an uphill slope 31. Below, simultaneous reference is made to FIG. 1 and FIG. 2, if not indicated otherwise.

The control arrangement 21 may be configured to, when the vehicle 1 is approaching an uphill slope 31, increase the speed of the vehicle 1 above a set speed before reaching the uphill slope 31 upon operating the propulsion system 5 in the default mode, and abstain from increasing the speed of the vehicle 1 above the set speed upon operating the propulsion system 5 in the energy conservation mode.

At least in some operational situations of the vehicle 1, the control arrangement 21 may, when the vehicle 1 is approaching an uphill slope 31, perform an increase in power output of the propulsion system 5 upon operating the propulsion system 5 in the default mode, and abstain from performing an increase in power output of the propulsion system 5 upon operating the propulsion system 5 in the energy conservation mode.

Due to this control, the control arrangement 21 can further increase the total energy efficiency of the vehicle 1 and improve the handling and driving dynamics of the vehicle 1, while minimizing wear and tear of wheel brakes of the vehicle 1, in an adaptive manner. This is because by increasing the speed of the vehicle 1 above the set speed, and/or performing an increase in power output of the propulsion system 5, when the propulsion system 5 is operating in the default mode and the vehicle 1 is approaching an uphill slope 31, the total energy efficiency of the vehicle 1 can be enhanced. This efficiency gain is achieved by avoiding high-load conditions on the propulsion system 5 while ascending the uphill slope 31, which are typically less efficient. That is, by increasing the speed of the vehicle 1 above the set speed in anticipation of the uphill slope 31, the vehicle 1 can tackle the incline more efficiently, using the gained momentum to reduce the strain on the propulsion system 5.

Likewise, the total energy efficiency of the vehicle 1 can be increased by abstaining from increasing the speed of the vehicle 1 above the set speed when the vehicle 1 is approaching the uphill slope upon operating the propulsion system 5 in the energy conservation mode, i.e., when the obtained probability has reached above the threshold probability. This is because the energy needed for performing a speed increase, and/or for performing an increase in power output of the propulsion system 5, is saved in situations having a high probability of a possible impending slowdown of a preceding vehicle 2. As a further result thereof, the use of the wheel brakes of the vehicle 1 can be minimized to reduce wear and tear thereof and to improve driving dynamics and handling of the vehicle 1 in an adaptive manner.

FIG. 3 illustrates a side-view of the vehicle 1 illustrated in FIG. 1 on a second example of a road section 9′. The second example of a road section 9′ has a different inclination profile than the road section 9 depicted in FIG. 2. The preceding vehicle 2 is also seen in FIG. 3. Moreover, as illustrated with the reference sign “9” in FIG. 1, the road section 9, 9′ depicted in FIG. 1 may comprise an inclination profile as depicted in FIG. 3.

In FIG. 3, the vehicle 1 is illustrated as travelling down a downhill slope 33, wherein the vehicle 1 is approaching an end 33′ of the downhill slope 33. Moreover, in FIG. 3, the preceding vehicle 2 is illustrated as traveling up an uphill slope 31′. Below, simultaneous reference is made to FIG. 1 and FIG. 3, if not indicated otherwise.

The control arrangement 21 may be configured to, when the vehicle 1 is approaching an end 33′ of a downhill slope 33, increase the speed of the vehicle 1 above a set speed before reaching the end 33′ of the downhill slope 33 upon operating the propulsion system 5 in the default mode, and abstain from increasing the speed of the vehicle 1 above the set speed upon operating the propulsion system 5 in the energy conservation mode.

At least in some operational situations of the vehicle 1, the control arrangement 21 may, when the vehicle 1 is approaching an end 33′ of a downhill slope 33, perform an increase in power output of the propulsion system 5 upon operating the propulsion system 5 in the default mode, and abstain from performing an increase in power output of the propulsion system 5 upon operating the propulsion system 5 in the energy conservation mode.

Due to this control, the control arrangement 21 can further increase the total energy efficiency of the vehicle 1 and improve the handling and driving dynamics of the vehicle 1, while minimizing wear and tear of wheel brakes of the vehicle 1, in an adaptive manner. This is because by increasing the speed of the vehicle 1 above the set speed, and/or performing an increase in power output of the propulsion system 5, when the propulsion system 5 is operated in the default mode and the vehicle 1 is approaching an end 33′ of a downhill slope 33, the total energy efficiency of the vehicle 1 can be enhanced. This efficiency gain is achieved by harnessing the gravitational assistance during the descent of the downhill slope 33. By proactively accelerating above the set speed before reaching the end 33′ of the downhill slope 33, the vehicle 1 can efficiently transition into level ground or an uphill slope 31′. This strategy can reduce the workload required by the propulsion system 5 for regaining speed on flatter terrain, typically requiring higher energy expenditure. Thus, increasing the speed of the vehicle 1 above the set speed as the vehicle 1 nears the end 33′ of a downhill slope 33 can optimize the use of gravitational momentum, thereby reducing the overall energy demand on the propulsion system 5 and improving the total energy efficiency of the vehicle 1.

Likewise, the total energy efficiency of the vehicle 1 can be increased by abstaining from increasing the speed of the vehicle 1 above the set speed upon operating the propulsion system 5 in the energy conservation mode, i.e., when the obtained probability of a possible impending slowdown of a preceding vehicle 2 has reached above the threshold probability. This is because the excess energy obtained by abstaining from increasing the speed of the vehicle 1 can be effectively utilized for other functions, such as a regenerative recuperation of potential energy while descending the downhill slope 33, in situations having a high probability of a possible impending slowdown of a preceding vehicle 2. Moreover, by abstaining from increasing the speed of the vehicle 1 above the set speed, the use of the wheel brakes can be minimized to reduce wear and tear thereof and to improve driving dynamics and handling of the vehicle 1 in an adaptive manner.

According to some embodiments, the control arrangement 21 is configured to adapt the execution of a pulse-and-glide procedure of the propulsion system 5 upon switching from the default mode to the energy conservation mode. The pulse-and-glide procedure may be managed by the control arrangement 21 of vehicle 1. A pulse-and-glide procedure is a technique designed to optimize the energy efficiency of the propulsion system 5. The pulse-and-glide procedure involves alternating between periods of acceleration, i.e., pulse phases, and coasting, i.e., glide phases. During a pulse phase, the control arrangement 21 may actively engage the propulsion system 5 to accelerate the vehicle 1, for example to a target speed. Once the target speed is achieved, the control arrangement 21 may transition the vehicle 1 into the glide phase. In this phase, the propulsion system 5 is either partially or completely disengaged, allowing vehicle 1 to coast, using its momentum. This glide phase significantly reduces the energy demand on the propulsion system 5, as the kinetic energy accumulated during the pulse phase is utilized to maintain the motion of the vehicle 1 with minimal additional power input.

In the pulse phases of the pulse-and-glide procedure, the propulsion system 5 can be set to operate in its optimal power band resulting in more efficient fuel usage or battery consumption, depending on the type of the propulsion system 5. This is because most propulsion systems operate more efficiently at specific power outputs than at lower, continuous outputs. Accordingly, in this manner, the pulse-and-glide procedure can result in overall energy savings for vehicle 1, as it can optimize the balance between power usage and conservation compared to a scenario where the propulsion system 5 maintains a constant but lower level of power output.

According to some embodiments, the control arrangement 21 may be configured to set a duration of one or both of pulse phases and glide phases of the pulse-and-glide procedure based on whether the propulsion system 5 is operated in the energy conservation mode or in the default mode.

Moreover, according to some embodiments, the control arrangement 21 may be configured to initiate a freewheeling phase of the propulsion system 5 upon switching from the default mode to the energy conservation mode. A freewheeling phase of the propulsion system 5 corresponds to a phase in which one or more power sources of the propulsion system 5 is/are mechanically disconnected from driven wheels of the vehicle 1, for example using a clutch or coupling mechanism.

Furthermore, according to embodiments in which the propulsion system 5 comprises an internal combustion engine 7, and the control arrangement 21 may be configured to initiate a motoring phase of the internal combustion engine 7 upon switching from the default mode to the energy conservation mode. A motoring phase refers to a phase in which no fuel is added to cylinders of the internal combustion engine 7 and a crankshaft of the engine is instead rotated by the momentum of the vehicle 1. Accordingly, during a motoring phase, the internal combustion engine 7 operates without combustion, utilizing the kinetic energy of the vehicle 1 to maintain the rotation of the crankshaft of the internal combustion engine 7.

Each of the freewheeling phase and the motoring phase may be part of a pulse-and-glide procedure performed by the control arrangement 21. That is, in these embodiments, the control arrangement 21 may, upon switching from the default mode to the energy conservation mode, initiate a planned pulse-and-glide procedure of the propulsion system 5 either by initiating a freewheeling phase or a motoring phase.

According to some embodiments, the control arrangement 21 is configured to obtain driving context data indicative of a driving environment of a current and/or upcoming road section 9, 9′ on which the vehicle 1 is/will be travelling. The driving context data may comprise at least one of a current speed of the vehicle 1 and an inclination ic1, ic2, ic3 of a current and/or upcoming road section 9, 9′ on which the vehicle 1 is/will be travelling.

In embodiments in which the propulsion system 5 comprises an internal combustion engine 7, the control arrangement 21 may be configured to select, based on the driving context data, between initiating a motoring phase of the internal combustion engine 7 or initiating a freewheeling phase of the propulsion system 5 upon switching from the default mode to the energy conservation mode.

In such embodiments, the selection may be based on an inclination ic1, ic2, ic3 of a current and/or upcoming road section 9, 9′ on which the vehicle 1 is/will be travelling and may be performed such that a motoring phase is selected if the vehicle 1 is, or shortly will be, located in a downhill slope 33, and such that a freewheeling phase is selected if the vehicle 1 is, or shortly will be, located in an uphill slope 31, 31′.

As mentioned, according to embodiments herein, the at least two modes of operation comprise a default mode and an energy conservation mode, wherein the energy conservation mode differs from the default mode by having a higher short term energy conservation aim than the default mode. Moreover, as indicated with the wording “higher short term energy conservation aim”, the control of operation of the propulsion system 5 performed by the control arrangement 21 in the energy conservation mode may have a higher aim to conserve energy during a short time period than the control of operation of the propulsion system 5 performed by the control arrangement 21 in the default mode. As indicated above, such a short period may range from a couple of tenths of a second to a number of seconds. In more detail, such short period may be within the range of 0.2-20 seconds, or may be within the range of 1-15 seconds.

Furthermore, according to some embodiments, the control arrangement 21 may be configured to perform a control of the propulsion system 5 determined to provide a long-term energy gain upon operating the propulsion system 5 in the default mode and may be configured to abstain from controlling the propulsion system 5 for a long-term energy gain upon operating the propulsion system 5 in the energy conservation mode. Such long-term energy gains may for example be achieved by investing energy for propulsion of the vehicle 1 in a certain driving situation, wherein the investment of energy is determined to result in a total reduction in long-term energy use. Examples of such driving situations are for example when the vehicle 1 is approaching an uphill slope 31 and when the vehicle 1 is approaching an end 33′ of a downhill slope 33. The wording “long term” in this context may correspond to a time period with a longer duration than the short period referred to above.

As an alternative, or in addition, according to embodiments herein, the control arrangement 21 may be configured to perform travel time saving measures upon operating the propulsion system 5 in the default mode and may be configured to abstain from performing travel time saving measures upon operating the propulsion system 5 in the energy conservation mode. An example of a travel time saving measure is to increase the speed of the vehicle 1 above a set speed in a certain drive situation. Examples of such driving situations are for example when the vehicle 1 is approaching an uphill slope 31 and when the vehicle 1 is approaching an end 33′ of a downhill slope 33.

The probability of a possible impending slowdown of the preceding vehicle 2, as referred to herein, may be represented by a value or number, such as a binary number. Likewise, the threshold probability, as referred to herein, may be represented by a value or number, such as a binary number. The threshold probability may be inputted into a memory of the control arrangement 21 or may be provided by the control arrangement 21. The control arrangement 21 may be configured to compare the probability of a possible impending slowdown of the preceding vehicle 2 with the threshold probability and may on the basis of such comparisons determine whether to operate the propulsion system 5 in the default mode or in the energy conservation mode, as referred to herein.

The control arrangement 21 of the vehicle 1 may be part of, or constitute, a cruise control arrangement of the vehicle 1. Due to the features of the control arrangement 21 according to embodiments herein, such a cruise control arrangement may be referred to as a cruise control with adaptive prediction, sometimes abbreviated CCAP. The set speed, as referred to herein, may be a set speed of such a cruise control arrangement of the vehicle 1.

FIG. 4 schematically illustrates a method 100 of controlling operation of a vehicle. The vehicle may be a vehicle 1 according to the embodiments explained with reference to FIG. 1-FIG. 3. Therefore, below, simultaneous reference is made to FIG. 1-FIG. 4, if not indicated otherwise.

The method 100 is a method of controlling operation of a vehicle 1, wherein the vehicle 1 comprises a propulsion system 5, and wherein the method 100 is performed by a control arrangement 21, the control arrangement 21 being configured to operate the propulsion system 5 in at least two modes of operation with differing energy conservation characteristics. The method 100 comprises the step of:
switching 110 between the at least two modes of operation based on an obtained probability of a possible impending slowdown of a preceding vehicle 2.

According to some embodiments, the at least two modes of operation comprise a default mode and an energy conservation mode, wherein the energy conservation mode differs from the default mode by having a higher short term energy conservation aim than the default mode, and wherein the method 100 comprises the step of:
switching 112 from the default mode to the energy conservation mode when the obtained probability reaches above a threshold probability.

Moreover, as indicated in FIG. 4, the method 100 may comprise the step of:
switching 114 from the energy conservation mode to the default mode when the obtained probability declines below the threshold probability.

Moreover, as indicated in FIG. 4, the method 100 may comprise the steps of, when the vehicle 1 is approaching an uphill slope 31:
performing 121 an increase in power output of the propulsion system 5 upon operating the propulsion system 5 in the default mode, and
abstaining 131 from performing an increase in power output of the propulsion system 5 upon operating the propulsion system 5 in the energy conservation mode.

Furthermore, as indicated in FIG. 4, the method 100 may comprise the steps of, when the vehicle 1 is approaching an uphill slope 31:
increasing 122 the speed of the vehicle 1 above a set speed upon operating the propulsion system 5 in the default mode, and
abstaining 132 from increasing the speed of the vehicle 1 above the set speed upon operating the propulsion system 5 in the energy conservation mode.

Moreover, as indicated in FIG. 4, the method 100 may comprise the steps of, when the vehicle 1 is approaching an end 33′ of a downhill slope 33:
performing 123 an increase in power output of the propulsion system 5 upon operating the propulsion system 5 in the default mode, and
abstaining 133 from performing an increase in power output of the propulsion system 5 upon operating the propulsion system 5 in the energy conservation mode.

Moreover, as indicated in FIG. 4, the method 100 may comprise the steps of, when the vehicle 1 is approaching an end 33′ of a downhill slope 33:
increasing 124 the speed of the vehicle 1 above a set speed upon operating the propulsion system 5 in the default mode, and
abstaining 134 from increasing the speed of the vehicle 1 above the set speed upon operating the propulsion system 5 in the energy conservation mode.

As indicated in FIG. 4, according to some embodiments, the method 100 comprises the step of:
adapting 141 the execution of a pulse-and-glide procedure of the propulsion system 5 upon switching from the default mode to the energy conservation mode.

Moreover, as indicated in FIG. 4, according to some embodiments, the method 100 comprises the step of:
initiating 143 a freewheeling phase of the propulsion system 5 upon switching from the default mode to the energy conservation mode.

According to some embodiments, the propulsion system 5 comprises an internal combustion engine 7. In such embodiments, the method 100 may comprise step of:
initiating 145 a motoring phase of the internal combustion engine 7 upon switching from the default mode to the energy conservation mode.

Moreover, according to some embodiments, the propulsion system 5 comprises an internal combustion engine 7, and wherein the method 100 comprises the steps of:
obtaining 101 driving context data indicative of a driving environment of a current and/or upcoming road section 9, 9′ on which the vehicle 1 is/will be travelling, and
selecting 140, based on the driving context data, between initiating a motoring phase of the internal combustion engine 7 or initiating a freewheeling phase of the propulsion system 5 upon switching from the default mode to the energy conservation mode.

The driving context data may comprise at least one of a current speed of the vehicle 1 and an inclination ic1, ic2, ic3 of a current and/or upcoming road section 9, 9′ on which the vehicle 1 is/will be travelling.

According to some embodiments, the propulsion system 5 comprises a regenerative braking system 8 controllable to regeneratively brake the vehicle 1, and wherein the method 100 comprises:
increasing 147 a braking level provided by the regenerative braking system 8 upon switching from the default mode to the energy conservation mode.

As indicated in FIG. 4, according to some embodiments, the method 100 comprises the step of:
obtaining 102 the probability of a possible impending slowdown of a preceding vehicle 2.

Moreover, as indicated in FIG. 4, the step of obtaining 102 the probability of a possible impending slowdown of the preceding vehicle 2 may comprise at least one of:
monitoring 103 signaling lights 24 of the preceding vehicle 2, and
monitoring 104 a lateral position of the preceding vehicle 2 relative to a road section 9, 9′ on which the preceding vehicle 2 is travelling.

As an alternative, or in addition, as indicated in FIG. 4, the step of obtaining 102 the probability of a possible impending slowdown of the preceding vehicle 2 may comprise the steps of:
obtaining 105 map data representative of road section 9, 9′ on which the preceding vehicle 2 is/will be travelling, and
obtaining 105′ the probability of a possible impending slowdown of the preceding vehicle 2 based on the map data.

As a further alternative, or in addition, as indicated in FIG. 4, the step of obtaining 102 the probability of a possible impending slowdown of the preceding vehicle 2 may comprise the steps of:
obtaining 106 historic data representative of historic speeds of vehicles on a road section 9, 9′ on which the preceding vehicle 2 is/will be travelling, and
obtaining 106′ the probability of a possible impending slowdown of the preceding vehicle 2 based on the historic data.

As an even further alternative, or in addition, as indicated in FIG. 4, the step of obtaining 102 the probability of a possible impending slowdown of the preceding vehicle 2 may comprise the steps of:
obtaining 107 communication data from an external sender 12, 13, and obtaining 107′ the probability of a possible impending slowdown of the preceding vehicle 2 based on the communication data.

It will be appreciated that the various embodiments described for the method 100 are all combinable with the control arrangement 21 as described herein. That is, the control arrangement 21 may be configured to perform any one of the method steps 101, 102, 103, 104, 105, 105′, 106, 106′, 107, 107′, 110, 112, 114, 121, 122, 123, 124, 131, 132, 133, 134, 140, 141, 143, 145, and 147 of the method 100.

FIG. 5 illustrates a computer-readable medium 200 comprising instructions which, when executed by a computer, cause the computer to carry out the method 100 according to some embodiments of the present disclosure. According to some embodiments, the computer-readable medium 200 comprises a computer program comprising instructions which, when the program is executed by a computer, cause the computer to carry out the method 100 according to some embodiments. The computer may be comprised in the control arrangement 21.

One skilled in the art will appreciate that the method 100 of controlling operation of a vehicle 1 may be implemented by programmed instructions. These programmed instructions are typically constituted by a computer program, which, when it is executed in the control arrangement 21, ensures that the control arrangement 21 carries out the desired control, such as the method steps 101, 102, 103, 104, 105, 105′, 106, 106′, 107, 107′, 110, 112, 114, 121, 122, 123, 124, 131, 132, 133, 134, 140, 141, 143, 145, and 147 described herein. The computer program is usually part of a computer program product which comprises a suitable digital storage medium on which the computer program is stored, such as the computer-readable medium 200 illustrated in FIG. 5. In other words, the computer program product may be a computer readable medium 200 and the computer program may be stored in the computer readable medium 200.

The control arrangement 21 may comprise a computer which may take the form of substantially any suitable type of hardware or hardware/firmware device implemented using processing circuity such as, but not limited to, a processor, Central Processing Unit (CPU), a controller, an arithmetic logic unit (ALU), a digital signal processor, an Application Specific Integrated Circuit (ASIC), a circuit for digital signal processing (digital signal processor, DSP), a microcomputer, a field programmable gate array (FPGA), a System-on-Chip (SoC), a programmable logic unit, a microprocessor, an application-specific integrated circuit, or any other device capable of electronically performing operations in a defined manner, or other processing logic that may interpret and execute instructions. The herein utilised expression “computer” may represent a processing circuitry comprising a plurality of processing circuits, such as, e.g., any, some or all of the ones mentioned above.

The control arrangement 21 may further comprise a memory unit, wherein the computer may be connected to the memory unit, which may provide the computer with, for example, stored program code and/or stored data which the computer may need to enable it to do calculations. The computer may also be adapted to store partial or final results of calculations in the memory unit. The memory unit may comprise a physical device utilised to store data or programs, i.e., sequences of instructions, on a temporary or permanent basis. According to some embodiments, the memory unit may comprise integrated circuits comprising silicon-based transistors. The memory unit may comprise e.g. a memory card, a flash memory, a USB memory, a hard disc, or another similar volatile or non-volatile storage unit for storing data such as e.g. ROM (Read-Only Memory), PROM (Programmable Read-Only Memory), EPROM (Erasable PROM), EEPROM (Electrically Erasable PROM), etc. in different embodiments.

The control arrangement 21 is connected to components of the vehicle 1 for receiving and/or sending input and output signals. These input and output signals may comprise waveforms, pulses, or other attributes which the input signal receiving devices can detect as information and which can be converted to signals processable by the control arrangement 21. These signals may then be supplied to the computer. One or more output signal sending devices may be arranged to convert calculation results from the computer to output signals for conveying to other parts of the vehicle's control system and/or the component or components for which the signals are intended. Each of the connections to the respective components of the vehicle 1 for receiving and sending input and output signals may take the form of one or more from among a cable, a data bus, e.g. a CAN (controller area network) bus, a MOST (media orientated systems transport) bus or some other bus configuration, or a wireless connection.

In the embodiments illustrated, the vehicle 1 comprises a control arrangement 21 but might alternatively be implemented wholly or partly in two or more control arrangements, two or more control arrangements, or two or more control units.

Control systems in modern vehicles generally comprise a communication bus system consisting of one or more communication buses for connecting a number of electronic control units (ECUs), or controllers, to various components on board the vehicle. Such a control system may comprise a large number of control units and taking care of a specific function may be shared between two or more of them. Vehicles and engines of the type here concerned are therefore often provided with significantly more control arrangements than depicted in FIG. 1, as one skilled in the art will surely appreciate.

The computer-readable medium 200 may be provided for instance in the form of a data carrier carrying computer program code for performing at least some of the method steps 101, 102, 103, 104, 105, 105′, 106, 106′, 107, 107′, 110, 112, 114, 121, 122, 123, 124, 131, 132, 133, 134, 140, 141, 143, 145, and 147 according to some embodiments of the method 100 when being loaded into one or more computers of the control arrangement 21. The data carrier may be, e.g. a CD ROM disc, as is illustrated in FIG. 5, or a ROM (read-only memory), a PROM (programmable read-only memory), an EPROM (erasable PROM), a flash memory, an EEPROM (electrically erasable PROM), a hard disc, a memory stick, an optical storage device, a magnetic storage device or any other appropriate medium such as a disk or tape that may hold machine readable data in a non-transitory manner. Accordingly, in some embodiments, the computer-readable medium 200 may be a non-transitory computer-readable medium, such as a tangible electronic, magnetic, optical, infrared, electromagnetic, and/or semiconductor system, apparatus, and/or device. The computer-readable medium 200 may furthermore be provided as computer program code on a server and may be downloaded to the control arrangement 21 remotely, e.g., over an Internet or an intranet connection, or via other wired or wireless communication systems.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A method of controlling operation of a vehicle, wherein the vehicle comprises a propulsion system, and wherein the method is performed by a control arrangement, the control arrangement being configured to operate the propulsion system in at least two modes of operation with differing energy conservation characteristics,
wherein the method comprises:
switching between the at least two modes of operation based on an obtained probability of a possible impending slowdown of a preceding vehicle.

2. The method according to claim 1, wherein the at least two modes of operation comprise a default mode and an energy conservation mode, wherein the energy conservation mode differs from the default mode by having a higher short term energy conservation aim than the default mode, and wherein the method comprises:
switching from the default mode to the energy conservation mode when the obtained probability reaches above a threshold probability.

3. The method according to claim 2, wherein the method comprises, when the vehicle is approaching an uphill slope:
increasing a speed of the vehicle above a set speed upon operating the propulsion system in the default mode; and
abstaining from increasing the speed of the vehicle above the set speed upon operating the propulsion system in the energy conservation mode.

4. The method according to claim 2, further comprising, when the vehicle is approaching an end of a downhill slope:
increasing the speed of the vehicle above a set speed upon operating the propulsion system in the default mode; and
abstaining from increasing the speed of the vehicle above the set speed upon operating the propulsion system in the energy conservation mode.

5. The method according to claim 2, further comprising:
adapting the execution of a pulse-and-glide procedure of the propulsion system upon switching to the energy conservation mode.

6. The method according to claim 2, further comprising:
initiating a freewheeling phase of the propulsion system upon switching to the energy conservation mode.

7. The method according to claim 2, wherein the propulsion system comprises an internal combustion engine, and wherein the method comprises:
initiating a motoring phase of the internal combustion engine upon switching to the energy conservation mode.

8. The method according to claim 6, wherein the propulsion system comprises an internal combustion engine, and wherein the method comprises:
obtaining driving context data indicative of a driving environment of a current and/or upcoming road section on which the vehicle is/will be travelling; and
selecting, based on the driving context data, between initiating a motoring phase of the internal combustion engine or initiating a freewheeling phase of the propulsion system upon switching to the energy conservation mode.

9. The method according to claim 8, wherein the driving context data comprises at least one of a current speed of the vehicle and an inclination of a current and/or upcoming road section on which the vehicle is/will be travelling.

10. The method according to claim 2, wherein the propulsion system comprises a regenerative braking system controllable to regeneratively brake the vehicle, and wherein the method comprises:
increasing a braking level provided by the regenerative braking system upon switching to the energy conservation mode.

11. The method according to claim 1, wherein the method comprises:
obtaining the probability of a possible impending slowdown of a preceding vehicle.

12. The method according to claim 11, wherein obtaining the probability of a possible impending slowdown of the preceding vehicle comprises at least one of:
monitoring signaling lights of the preceding vehicle; and
monitoring a lateral position of the preceding vehicle relative to a road section on which the preceding vehicle is travelling.

13. The method according to claim 11, wherein obtaining the probability of a possible impending slowdown of the preceding vehicle comprises:
obtaining map data representative of road section on which the preceding vehicle is/will be travelling; and
obtaining the probability of a possible impending slowdown of the preceding vehicle based on the map data.

14. The method according to claims 11, wherein obtaining the probability of a possible impending slowdown of the preceding vehicle comprises:
obtaining historic data representative of historic speeds of vehicles on a road section on which the preceding vehicle is/will be travelling; and
obtaining the probability of a possible impending slowdown of the preceding vehicle based on the historic data.

15. The method according to claims 11, wherein obtaining the probability of a possible impending slowdown of the preceding vehicle comprises:
obtaining communication data from an external sender; and
obtaining the probability of a possible impending slowdown of the preceding vehicle based on the communication data.

16. A computer program product stored on a non-transitory computer-readable medium, said computer program product for use in operation of a vehicle, wherein the vehicle comprises a propulsion system and a control arrangement configured to operate the propulsion system in at least two modes of operation with differing energy conservation characteristics, wherein said computer program product comprising computer instructions to cause one or more computing devices of the control arrangement to:
switch between the at least two modes of operation based on an obtained probability of a possible impending slowdown of a preceding vehicle.

17. (canceled)

18. A control arrangement configured to control operation of a vehicle, wherein the vehicle comprises a propulsion system, and wherein the control arrangement is configured to operate the propulsion system in at least two modes of operation with differing energy conservation characteristics,
wherein the control arrangement is configured to:
switch between the at least two modes of operation based on an obtained probability of a possible impending slowdown of a preceding vehicle.

19. A vehicle comprising a propulsion system and a control arrangement where the control arrangement is configured to operate the propulsion system in at least two modes of operation with differing energy conservation characteristics,
wherein the control arrangement is configured to:
switch between the at least two modes of operation based on an obtained probability of a possible impending slowdown of a preceding vehicle.

20. The vehicle according to claim 19, wherein the vehicle is a heavy road vehicle.
